(19) United States
(12) Patent Application Publication
(10) Pub. No.: US 2025/0193344 A1
(43) Pub. Date: Jun. 12, 2025

(54) Generating a 3D Representation of a Head of a Participant in a Video Communication Session

(71) Applicant: Telefonaktiebolaget LM Ericsson (publ), Stockholm (SE)

(72) Inventors: Joerg Christian Ewert, Aachen (DE); Ali El Essaili, Aachen (DE); Natalya Tyudina, Aachen (DE); Esra Akan, Aachen (DE)

(21) Appl. No.: 18/841,174

(22) PCT Filed: Mar. 14, 2022
(86) PCT No.: PCT/EP2022/056486

§ 371 Date: Aug. 23, 2024

(51) Int. Cl. H04N 7/15; G06T 13/40; G06T 19/00; G06T 19/20; G06V 40/16

(52) U.S. Cl. CPC H04N 7/157; G06T 13/40; G06T 19/006; G06T 19/20; G06V 40/165; G06T 2200/08

(57) ABSTRACT

A computing device for generating a three-dimensional (3D) representation of a head of a participant in a video communication session is provided. The computing device comprises processing circuitry causing the computing device to be operative to acquire a captured 3D representation (300) of the head, and to identify positions (1-27) of a set of facial landmarks in the captured 3D representation (300). The set of facial landmarks comprises facial landmarks indicative of a boundary of the human face. The computing device is further operative to determine a pose of the head, and to determine a boundary (310) between an inner part (320) and an outer part (330) of the captured 3D representation (300), based on the identified positions (1-27) of the set of facial landmarks. The inner part (320) of the captured 3D representation represents the face of the participant. The computing device is further operative to generate an avatar representation corresponding to the outer part (330) of the captured 3D representation (300), using a Machine-Learning (ML) model trained for human heads, with the determined pose of the head as input.

### TECHNICAL FIELD

The invention relates to a computing device for generating a three-dimensional (3D) representation of a head of a participant in a video communication session, a method of generating a 3D representation of a head of a participant in a video communication session, a corresponding computer program, a corresponding computer-readable data carrier, and a corresponding data carrier signal.

### BACKGROUND

Different alternatives for generating and displaying three-dimensional (3D) representations of human heads to a viewer, e.g., during a video communication session between two or more participants, are known.

A first type of solutions is based on computer-generated 3D avatars. Such avatars are generated using Machine-Learning (ML) models which are trained using captured 3D representations of human heads, and subsequently adapted to a specific head using a two-dimensional (2D) image representing the head. During use, the head pose of the sending participant's head is continuously detected and used as input to the ML model, which generates a dynamically animated avatar reflecting the actual movement of the sending participant's head. A considerable improvement in generated 3D avatars has been achieved in recent years through the usage of Generative Adversarial Networks (GANs), as has been demonstrated by H. Luo et al. (“Normalized Avatar Synthesis Using StyleGAN and Perceptual Refinement”, arXiv: 2106.11423, arXiv, 2021).

A second type of solutions relies on capturing the head of the sending participant using 3D sensors, such as stereo cameras, and transmitting the captured 3D representation in real time for display to a receiving participant, e.g., as a point-cloud stream or a mesh stream. Solutions based on real-time capture and transmission are superior in representing details of the captured head, as compared to animated 3D avatars. These details, in particular details of the captured face, are important for conveying the emotions of the sending participant. However, transmitting 3D captured representations of heads in real-time requires considerable larger bandwidths of the communication links used for transmitting the captured 3D data, e.g., as a point-cloud or mesh stream. In addition, today's solution which rely on capturing the sending participant's head in real time typically require relatively complex 3D sensors, such as several cameras, to guarantee that the outer parts of the sending participant's head (outside the face) are captured completely when the head moves, which increases complexity and costs.

### SUMMARY

It is an object of the invention to provide an improved alternative to the above techniques and prior art.

More specifically, it is an object of the invention to provide improved solutions for generating 3D representations of human heads based on capturing the head using a 3D sensor device.

These and other objects of the invention are achieved by means of different aspects of the invention, as defined by the independent claims. Embodiments of the invention are characterized by the dependent claims.

According to a first aspect of the invention, a computing device for generating a 3D representation of a head of a participant in a video communication session is provided. The computing device comprises processing circuitry causing the computing device to be operative to acquire a captured 3D representation of the head, and to identify positions of a set of facial landmarks in the captured 3D representation. The set of facial landmarks comprises facial landmarks which are indicative of a boundary of the human face. The computing device is further operative to determine a pose of the head, and to determine a boundary between an inner part and an outer part of the captured 3D representation. The boundary is determined based on the identified positions of the set of facial landmarks. The inner part of the captured 3D representation represents the face of the participant. The computing device is further operative to generate an avatar representation corresponding to the outer part of the captured 3D representation. The avatar representation is generated using an ML model which is trained for human heads. The determined pose of the head is used as input to the ML model.

According to a second aspect of the invention, a method of generating a 3D representation of a head of a participant in a video communication session is provided. The method is performed by a computing device and comprises acquiring a captured 3D representation of the head, and identifying positions of a set of facial landmarks in the captured 3D representation. The set of facial landmarks comprises facial landmarks which are indicative of a boundary of the human face. The method further comprises determining a pose of the head, and determining a boundary between an inner part and an outer part of the captured 3D representation. The boundary is determined based on the identified positions of the set of facial landmarks. The inner part of the captured 3D representation represents the face of the participant. The method further comprises generating an avatar representation corresponding to the outer part of the captured 3D representation. The avatar representation is generated using an ML model which is trained for human heads. The determined pose of the head is used as input for the ML model.

According to a third aspect of the invention, a computer program is provided. The computer program comprises instructions which, when the computer program is executed by computing device, cause the computing device to carry out the method according to an embodiment of the second aspect of the invention.

According to a fourth aspect of the invention, a computer-readable data carrier is provided. The computer-readable data carrier has stored thereon the computer program according to the third aspect of the invention.

According to a fifth aspect of the invention, a data carrier signal is provided. The data carrier signal carries the computer program according to the third aspect of the invention.

The invention makes use of an understanding that a 3D representation of a head of a participant in a video communication session may be generated based on extracting an inner part of the captured 3D representation of the head and making that inner part available for display to a receiving user, e.g., as a real-time stream. The extracted inner part corresponds to the facial region, or face of the head, which generally includes the eyes, nose, ears, and mouth. The remainder of the captured 3D representation, herein referred to as the outer part, represents parts of the head outside the face. This outer part is replaced by an avatar which is generated using an ML model trained for human heads, using the pose of the captured head as input for the ML model. This results in an animated avatar which reflects the actual pose and movement of the captured head.

Embodiments of the invention are advantageous in that a receiving user who is viewing the generated 3D representation of the captured head does not suffer from an incompletely captured 3D representation of the head, which may occur due to limitations in the 3D sensors used for capturing 3D representations. At the same time, the detailed structure and movements of the captured head's face and its parts, which are important for conveying emotions in inter-human communications, are retained. Thereby, user experience may be improved. Embodiments of the invention are further advantageous in that the amount of data, which is captured as the 3D representation of the head, which needs to be transferred to the receiving user in real-time, e.g., by streaming, is reduced. This is the case since only a subset of the captured 3D data, the inner part of the captured 3D representation representing the face of the captured head, needs to be transferred from the 3D sensor to the display device. Thereby, the bandwidth required for conducting a 3D video communication session is reduced.

Even though advantages of the invention have in some cases been described with reference to embodiments of the first aspect of the invention, corresponding reasoning applies to embodiments of other aspects of the invention. Further objectives of, features of, and advantages with, the invention will become apparent when studying the following detailed disclosure, the drawings and the appended claims. Those skilled in the art realize that different features of the invention can be combined to create embodiments other than those described in the following.

### BRIEF DESCRIPTION OF THE DRAWINGS

The above, as well as additional objects, features and advantages of the invention, will be better understood through the following illustrative and non-limiting detailed description of embodiments of the invention, with reference to the appended drawings, in which:

FIG. 1 illustrates a video communication session between two participants, in accordance with embodiments of the invention.

FIG. 2 illustrates a captured 3D representation of a human head, in accordance with embodiments of the invention.

FIG. 3 illustrates determining a boundary between an inner part and an outer part of a captured 3D representation of a head, using facial landmarks, in accordance with embodiments of the invention.

FIG. 4 schematically illustrates generating a 3D representation of a head of a participant in a video communication session, in accordance with embodiments of the invention.

FIGS. 5A-5C show sequence diagrams illustrating generating a 3D representation of a head of a participant in a video communication session, in accordance with embodiments of the invention.

FIG. 6 schematically illustrates the computing device for generating a 3D representation of a head of a participant in a video communication session, in accordance with embodiments of the invention.

FIG. 7 shows a method of generating a 3D representation of a head of a participant in a video communication session, in accordance with embodiments of the invention.

All the figures are schematic, not necessarily to scale, and generally only show parts which are necessary in order to elucidate the invention, wherein other parts may be omitted or merely suggested.

### DETAILED DESCRIPTION

The invention will now be described more fully herein after with reference to the accompanying drawings, in which certain embodiments of the invention are shown. This invention may, however, be embodied in many different forms and should not be construed as limited to the embodiments set forth herein. Rather, these embodiments are provided by way of example so that this disclosure will be thorough and complete, and will fully convey the scope of the invention to those skilled in the art.

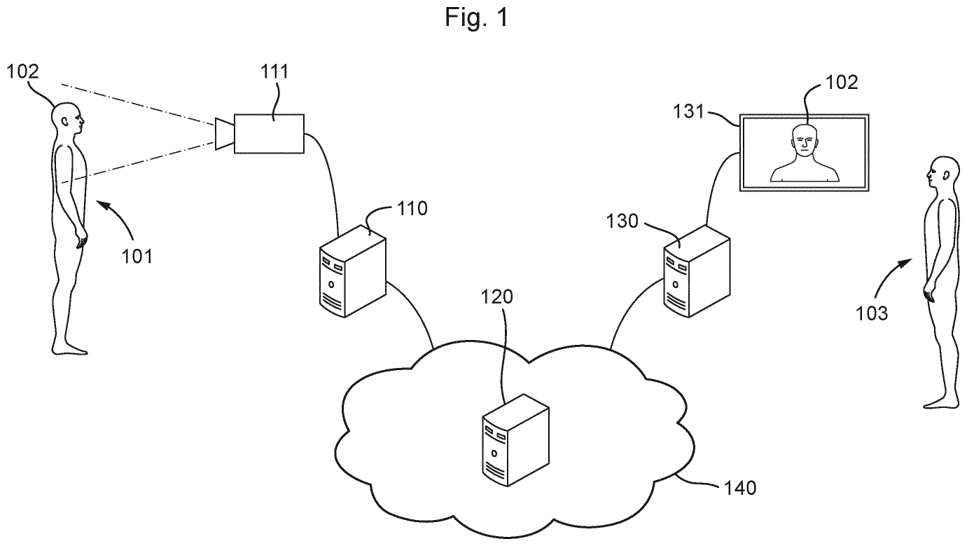

FIG. 1 illustrates a video communication session between two participants 101 and 103, exemplified as a unidirectional video communication session between a sending computing device 110 and a receiving computing device 130. During the video communication session, which may also be referred to as a 3D video communication session, a 3D representation of the head 102 of the sending participant 101 is captured using a 3D sensor 111, such as a stereo camera, and transmitted (e.g., streamed) over a communications network 140 to the receiving computing device 130 for display to the receiving participant 103, using a display device 131 such as a computer display or a Head-Mounted Display (HMD). It is noted that embodiments of the invention are not limited to unidirectional video communication sessions between two participants, as illustrated in FIG. 1. Rather, embodiments of the invention may be envisaged which enable unidirectional (e.g., a presentation streamed from a presenter to many viewers) or bidirectional (e.g., a video call during a virtual meeting) video communication sessions between two or more participants. More specifically, in the case of a bidirectional video communication session, embodiments of invention also support generating a 3D representation of a head of another participant, in FIG. 1 the head of the participant 103, in the reverse direction. Hence, a computing device supporting bidirectional video communication sessions in accordance with embodiments of the invention comprises, or is operatively connected to, both a 3D sensor 111 and a display device 131.

The computing device for generating a 3D representation of a head 102 of a participant 101 in a video communication session may be embodied in different forms, e.g., as the sending computing device 110, as the receiving computing device 130, as an edge computing device 120 which is provided at the edge of the communications network 140 through which the traffic between the sending computing device 110 and the receiving computing device 130 passes, or as a combination thereof. The edge computing device 120 may, e.g., be provided close to a Radio Access Network (RAN) which is part of the communications network 140, and through which the sending computing device 110 and/or the receiving computing device 130 communicate with each other and/or with the edge computing device 120.

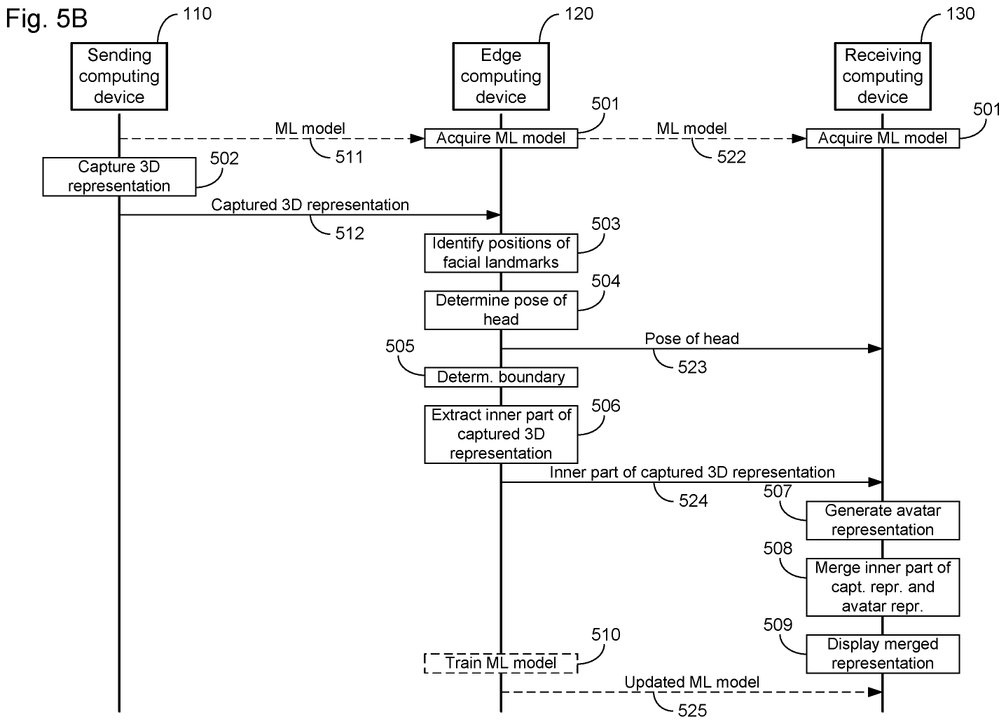

The computing device for generating a 3D representation of a head 102 of a participant 101 in a video communication session, in particular if embodied as the sending computing device 110 or as the receiving computing device 130, may be any one of a smartphone, a tablet, a laptop, an Augmented-Reality (AR) device, a Virtual-Reality (VR) device, a Mixed-Reality (MR) device, an extended-Reality (XR) device, and an HMD. Alternatively, the computing device for generating a 3D representation of a head 102 of a participant 101 in a video communication session, in particular if embodied as the edge computing device 120, may be any one of an edge server, an application server, and a cloud computer. It will also be appreciated that the computing device for generating a 3D representation of a head 102 may be embodied in a distributed fashion. That is, the different operations involved in generating a 3D representation of the head 102, described in further detail below, may be distributed among more than one of the sending computing device 110, the edge computing device 120, and the receiving computing device 130, and performed in a collaborative fashion. Illustrative examples for distributing the different operations among the sending computing device 110, the edge computing device 120, and the receiving computing device 130, in a collaborative fashion are illustrated in FIGS. 5A-5C and elucidated in more detail further below.

Throughout this disclosure, embodiments of the invention are described in relation to generating a 3D representation of a human head 102, which includes the face. The human face includes the eyes, nose, ears, and mouth. In inter-human communications, the detailed structure and movements of the face and its parts are important for conveying emotions, e.g., between the participants 101 and 103.

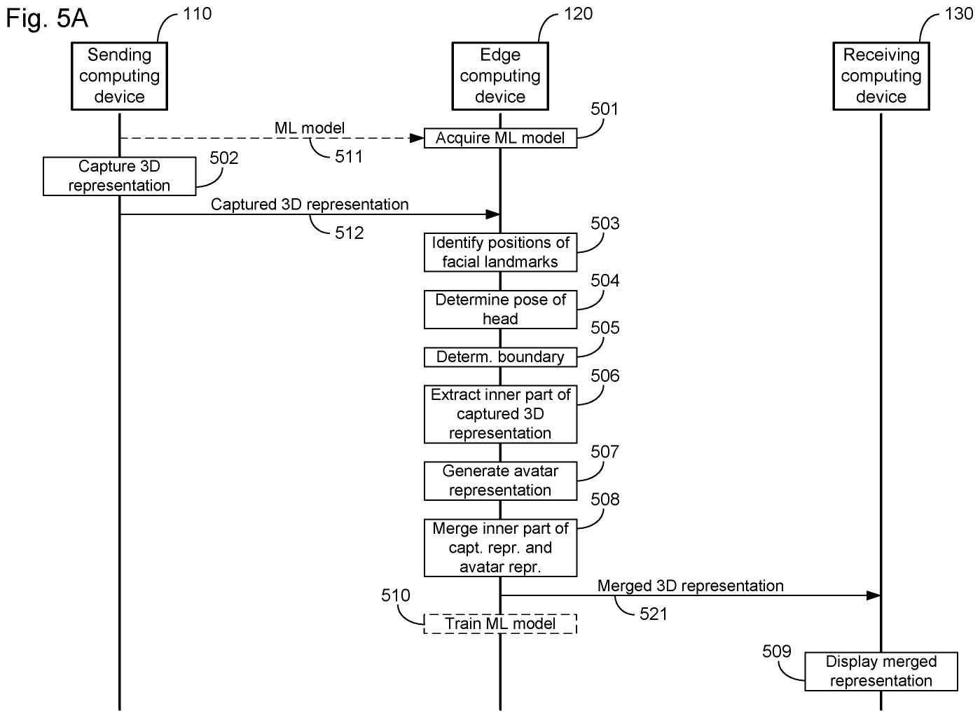

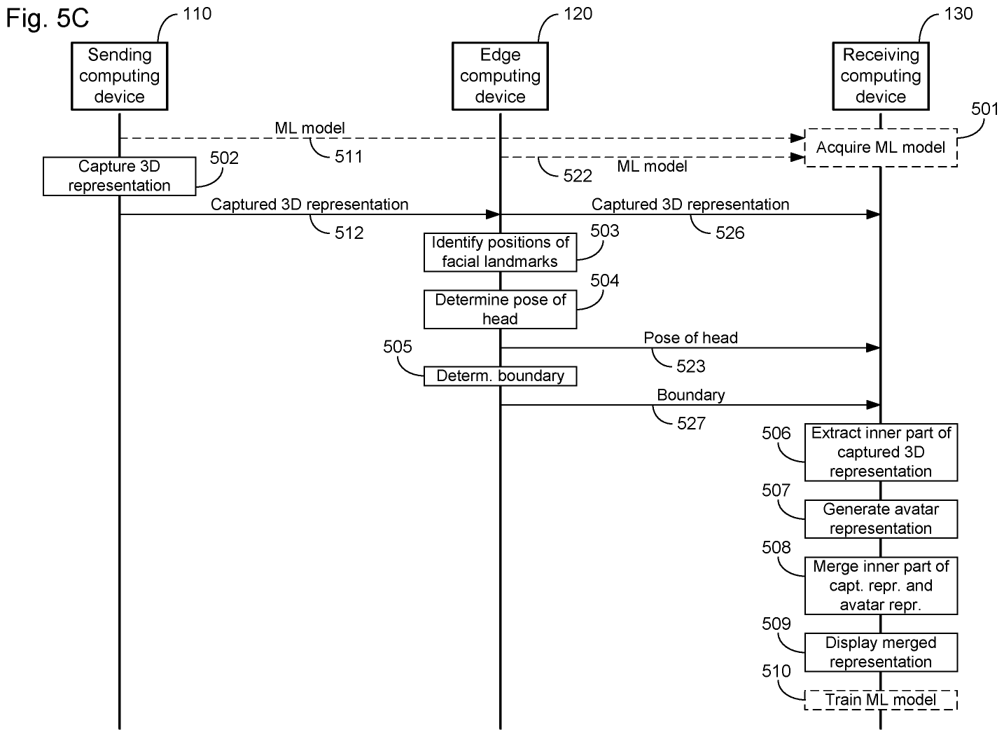

In the following, and with reference to FIG. 6, embodiments 600 of the computing device for generating a 3D representation of a head 102 of a participant 101 in a video communication session (for brevity also referred to as the “computing device”) are described in more detail. Additional reference is made to FIG. 4, which schematically illustrates the flow of data in generating a 3D representation of a head of a participant in a video communication session.

The computing device 600 comprises processing circuitry 602 which causes the computing device 600 to be operative to acquire a captured 3D representation of the head 102. This may, e.g., be achieved by capturing 502 the 3D representation of the head using the 3D sensor 111. Optionally, if the computing device 600 is embodied as the sending computing device 110, the computing device 110 may comprise the 3D sensor 111. Alternatively, the computing device 110 may be operatively connected to the 3D sensor 111. For instance, the 3D sensor 111 may be a separate unit which is connected to the computing device 110 via an interface circuit (“I/O interface” in FIG. 6) using any wired or wireless technology known in the art, such as a Universal Serial Bus (USB), Lighting, High-Definition Multimedia Interface (HDMI), Bluetooth, or the like. Alternatively, if the computing device 600 is embodied as the edge computing device 120 or as the receiving computing device 130, or a combination thereof, the computing device 120/130 may be operative to acquire the captured 3D representation of the head 102 by receiving 512 the captured 3D representation via the communications network 140, e.g., as a data stream directly (or indirectly via the sending computing device 110) from the 3D sensor 111, e.g., using the Real-Time Protocol (RTP), the Secure Real-time Transport Protocol (SRTP), or any other suitable protocol.

The 3D sensor 111 may comprise one or more of a 3D camera (aka stereo camera), an optical 3D sensor, a LiDAR, and a 2D camera. Optical 3D sensors may be used to capture and reconstruct the 3D depth of real-world objects, such as the head 102. Depending on the source of the radiation used, optical 3D sensors may be divided in two categories, passive and active. Stereoscopic sensors, Shape-from-Silhouettes (SfS) sensors, and Shape-from-Texture (SfT) sensors, are examples of passive 3D sensors, which do not emit any kind of radiation themselves. The 3D sensors collect images of the scene, e.g., the head 102, optionally from different points of view or with different optical setups. Then the images are analyzed to compute the 3D depth of points in the captured scene, e.g., points representing the surface of the head 102 and its parts. On the contrary, active 3D sensors emit radiation, e.g., electromagnetic waves such as light, and the interaction between the object, such as the head 102, and the radiation is captured by the sensor. From the analysis of the captured data, and based on the properties of the emitted radiation, the coordinates of the points in the captured scene, e.g., points representing the surface of the head 102 and its parts, are obtained. Time-of-Flight (ToF) sensors, phase-shift sensors, and active-triangulation sensors, are examples of active 3D sensors. The output of an optical 3D sensor is typically a depth map image.

LIDAR (Light Detection And Ranging) may be used to measure distances (aka “ranging”) by illuminating the target, such as the head 102, with light and then measuring the reflections with an optical sensor. LiDAR sensors may operate in the ultraviolet, visible, or infrared spectrum. Since laser light, which is typically used, is collimated, the LiDAR sensor needs to scan the scene in order to generate an image with a desired field-of-view. The output of a LIDAR sensor is typically a point cloud which subsequently may be enriched with other sensor data, such as RGB data from a conventional (2D) camera which may be comprised in the 3D sensor 111.

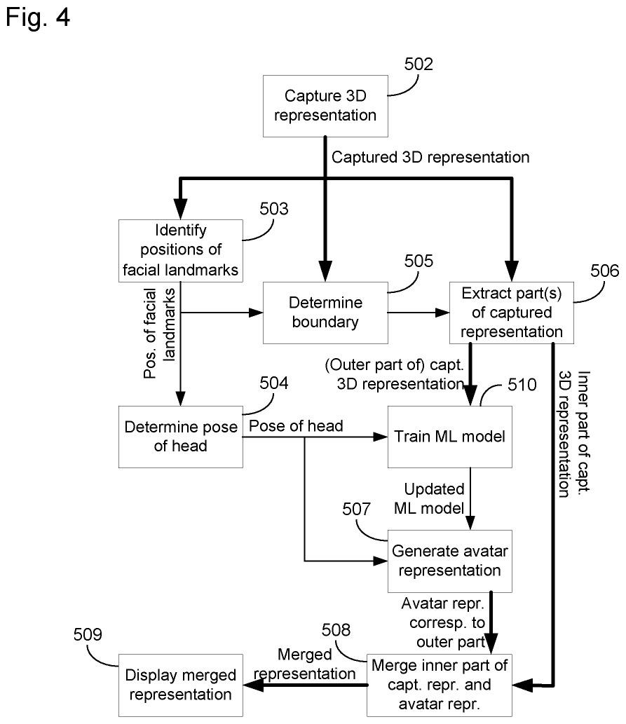

The processing circuitry 602 further causes the computing device 600 to be operative to identify 503 positions of a set of facial landmarks (aka “facial keypoints” or simply “keypoints”) in the captured 3D representation. The set of facial landmarks comprises facial landmarks which are indicative of a boundary of the human face. Different sets of facial landmarks are used in the art. As an example, “Fast Facial Landmark Detection and Applications: A Survey” (by K. S. Khabarlak and L. S. Koriashkina, arXiv: 2101.10808v2, arXiv, 2021) lists different sets comprising between 21 and 98 facial landmarks. Typically, a subset of facial landmarks of any given set are indicative of a boundary of the human face. In FIG. 3, an example set of facial landmarks 1 through 27 which are indicative of a boundary of the human face, as described in “Facial Landmarks for Face Recognition with Dlib” (https://sefiks.com/2020/11/20/facial-landmarks-for-face-recognition-with-dlib/, retrieved on 2022 Mar. 11), is reproduced. For illustrative purposes, the facial landmarks 1 to 27 are overlaid onto a sketch of a captured 3D representation 300 of the head 102 at representative positions.

Using an ML model such as a neural network, the set of facial landmarks can be detected in a (2D) image of a face and the (3D) positions of the facial landmarks can be determined. This may be achieved using a known facial-landmark detection algorithm, e.g., as described in “Fast Facial Landmark Detection and Applications: A Survey”, using the Dlib library (see “Facial Landmarks for Face Recognition with Dlib”) or the OpenCV library (see, e.g., “Head Pose Estimation using Python”, https://towardsdatascience.com/head-pose-estimation-using-python-d165d3541600, retrieved on 2022 Mar. 11).

The processing circuitry 602 further causes the computing device 600 to be operative to determine 504 a pose of the head 102 (also referred to as “head pose”). The determined pose of the head 102 may be expressed in terms of Euler angles, e.g., pitch, yaw, and roll, but embodiments of the invention may also rely on alternative sets of angles. The pose of the head 102 may, e.g., be determined 504 using a similar approach as described above in relation to identifying 503 positions of the set of facial landmarks. For instance, the head pose can be determined based on facial landmarks using the OpenCV library (see “Head Pose Estimation using Python”). This example illustrates how the head pose can be determined using six facial landmarks only, identifying the edge of the eyes, the nose, the chin, and the edge of the mouth. The set of facial landmarks which is used for determining 504 the head pose may be different from the set of facial landmarks which are indicative of a boundary of the human face. Alternatively, the set of facial landmarks which are indicative of a boundary of the human face may comprise landmarks which are indicative of a pose of the human head. Different techniques for determining the head pose from a (2D) image of a head are known in the art, see, e.g., “Fast Facial Landmark Detection and Applications: A Survey”.

The processing circuitry 602 further causes the computing device 600 to be operative to determine 505 a boundary between an inner part and an outer part of the captured 3D representation. The inner part of the captured 3D representation represents the face of the participant 101, and may also be referred to as the facial part of the captured 3D representation. The boundary is determined 505 based on the identified 503 positions of the set of facial landmarks, in particular the facial landmarks which are indicative of a boundary of the human face. In practice, the boundary between the inner part and the outer part of the captured 3D representation may be determined 505 by fitting a 2D shape, such as an oval shape, to the identified positions of the set of facial landmarks which are indicative of a boundary of the human face. As an example, an oval shape 310 which is fitted to the set of facial landmarks 1 to 27 is illustrated in FIG. 3. The boundary 310 separates the inner (facial) part 320 from the outer part 330 of the captured 3D representation 300.

As an alternative to fitting a 2D shape to the identified positions of the set of facial landmarks which are indicative of a boundary of the human face, the boundary between the inner part and the outer part of the captured 3D representation may be determined 505 by first fitting a 3D shape such as an ovoid or an ellipsoid to the captured 3D representation of the head 102. Subsequently, the identified positions of the set of facial landmarks which are indicative of a boundary of the human face are projected onto the fitted 3D shape, either using surface normal or projections to the origin or a coordinate system used for the captured 3D representation, which advantageously is close to the center of the head 102. The projected positions of the facial landmarks are points on the surface of the fitted 3D shape. Then, a 2D shape, such as an oval shape, is fitted to the points on the surface of the fitted 3D shape.

It will be appreciated that embodiments of the invention are not limited to using oval shapes in determining 505 the boundary between the inner part and the outer part of the captured 3D representation. In particular, ellipses or circles may be used, which are special cases of an oval shape. Embodiments of the invention may also rely on spline shapes.

The processing circuitry 602 further causes the computing device 600 to be operative to generate 507 an avatar representation corresponding to the outer part 330 of the captured 3D representation 300. The outer part 330 of the captured 3D representation 300 is defined by the determined 505 boundary 310 between the inner part 320 and the outer part 330 of the captured 3D representation 300. In practice, since the boundary 310 is represented by a 2D shape, such as an oval, the avatar representation corresponding to the outer part 330 of the captured 3D representation 300 is generated for parts of the head 102 outside the 2D shape representing the boundary 310 between the inner part 320 and the outer part 330 of the captured 3D representation 300. If the generated avatar representation is a point cloud, the generated points are outside the 2D shape representing the boundary 310.

The avatar representation is generated 507 using an ML model which has been trained for human heads. The determined 504 pose of the head is used as input to the ML model. The generated 507 avatar representation corresponding to the outer part 330 of the captured 3D representation 300 is an animated representation of the outer part of the head 102, i.e., the parts of the head 102 which are outside the face, as defined by the boundary 310 between the inner part 320 and the outer part 330 of the captured 3D representation 300. As an example, the avatar representation corresponding to the outer part 330 of the captured 3D representation 300 may be generated using a GAN, as described in “Normalized Avatar Synthesis Using StyleGAN and Perceptual Refinement”. The ML model may be a generic ML model which has been trained for human heads in general.

Alternatively, the ML model may be a specific ML model which has been trained for one or more of specific types of human heads, the types including a gender, an age or age range, skin color, hair type, etc. I will also be appreciated that embodiments of the invention may be envisaged for generating a 3D representation of the head of an animal.

The processing circuitry 602 optionally further causes the computing device 600 to be operative to extract 506 the inner part 320 of the captured 3D representation 300, and to merge 508 the extracted 506 inner part 320 of the captured 3D representation 300 and the generated 507 avatar representation into a merged 3D representation of the head 102. In other words, the inner part 320 of the captured 3D representation 300, which is the subset of the data captured by the 3D sensor 111 which represents the face of the head 102, i.e., is inside the determined 505 boundary 310 between the inner part 320 and the outer part 330 (which boundary 310 is represented by a 2D shape, such as an oval), is merged 508 with the generated 507 avatar representation which corresponds to the outer part 330 of the captured 3D representation 300. In practice, this amounts to replacing the outer part 330 of the captured 3D representation 300 with the generated avatar representation, i.e., an animated (computer generated) representation of the outer part of the head 102, while keeping the inner part 320 of the captured 3D representation 300, i.e., the captured real-time representing the face of the head 102. More specifically, if the captured 3D representational and the generated avatar representation are point clouds, extracting the inner part 320 of the captured 3D representation 300 amounts to selecting points from the point cloud representing the captured 3D representation 300 which have coordinates which are inside the determined boundary 310 between the inner part 320 and the outer part 330 of the captured 3D representation 300, i.e., points which are inside the 2D shape representing the boundary 310. Correspondingly, the points of the point cloud representing the generated avatar representation have coordinates which are outside the determined boundary 310 between the inner part 320 and the outer part 330 of the captured 3D representation 300, i.e., these are points which are outside the 2D shape representing the boundary 310. Similarly, merging 508 of the extracted inner part 320 of the captured 3D representation 300 and the generated avatar representation into a merged 3D representation of the head amounts to combining the different sets of points (represented by separate point clouds) into a single point cloud. If the captured 3D representation and the generated avatar representation are represented in a different format than point clouds, such as meshes och depth map images, they can optionally be converted into point clouds before extracting 506 the inner part 320 of the captured 3D representation 300 and merging 508 the extracted 506 inner part 320 of the captured 3D representation 300 and the generated 507 avatar representation into a merged 3D representation of the head 102. Alternatively, extracting 506 the inner part 320 of the captured 3D representation 300 and the merging 508 the extracted 506 inner part 320 of the captured 3D representation 300 and the generated 507 avatar representation into a merged 3D representation of the head 102 may be performed in the native format of the captured 3D representation and the generated avatar representation, without converting the data to point clouds.

The processing circuitry 602 optionally further causes the computing device 600 to be operative to display 509 the merged 3D representation of the head 102 using the display device 131. Optionally, the display device 131 may be comprised in the computing device 600, if the computing device is embodied as the receiving computing device 130. The display device 131 may be any one of a computer display, a television, an AR device, a VR device, an MR device, an XR device, and an HMD device.

By replacing the outer part 330 of the captured 3D representation 300 of the head 102, which needs to be transmitted in real-time from the sending computing device 110 to the receiving computing device 130 for rendering on the display device 131, with a generated avatar representation, the amount of captured data which needs to be transmitted over the communications network 140 in real-time may be reduced.

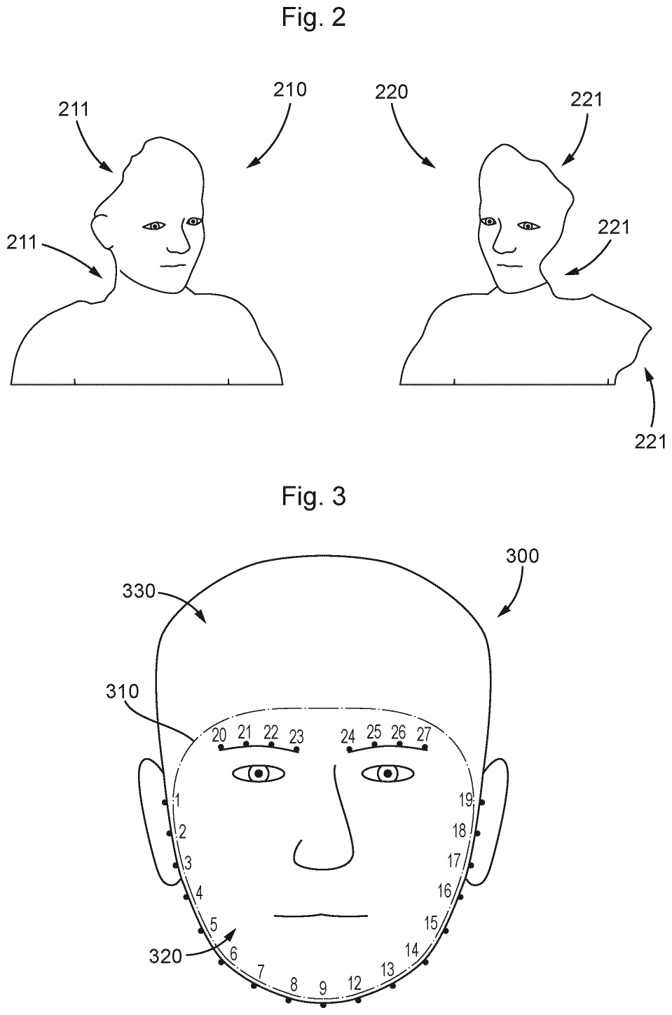

A further advantage arises from the fact that the captured 3D representation of the head 102 may be incomplete, in particular within the outer part 320 of the head 102, i.e., outside the facial region. This may happen when the head 102 moves, and due to limitations in the field-of-view of the 3D sensor 111. Such a situation is illustrated in FIG. 2, which shows missing patches 211 and 221 in the 3D representation captured at different poses 210 and 220 of the head 102 relative to the 3D sensor 111. By replacing the outer part 330 of captured 3D representation 300 of the head 102 with a generated avatar representation, the merged 3D representation which is displayed using the display device 131 does not suffer from missing captured data within the outer part 330 of the captured 3D representation 300. Thereby, the user experience of the viewing participant 103 is improved, as the displayed merged 3D representation of the head 102 is less likely to suffer from missing captured data.

Optionally, the ML model, which is used to generate 507 an avatar representation corresponding to the outer part 330 of the captured 3D representation 300, is trained 510 for the head 102 of the participant 101. In other words, the ML model is specifically trained 510 for the head 102 which is captured during the video communication session. Thereby, the user experience during the video communication session, in particular that of the receiving participant 103 viewing the merged 3D representation of the head 102, is improved.

The processing circuitry 602 optionally further causes the computing device 600 to be operative to acquire the ML model from a data storage associated with the participant 101. Preferably, the acquired ML model is trained for the head 102 of the participant 101, herein also referred to as a “participant-specific ML model”. For instance, the participant-specific ML model may be stored in a user device associated with the participant 101, such as the sending computing device 110 or a cloud storage. When the participant 101 initiates or joins a video communication session, the participant-specific ML model may be retrieved 511/522 by the computing device 600 and used in generating 507 the avatar representation corresponding to the outer part of the captured 3D representation. For instance, the participant-specific ML model may be transmitted 511/522 from the sending computing device 110, which is a personal device used by the sending participant 101, to the computing device 600 embodied as the edge computing device 120 and/or as the receiving computing device 130. Alternatively, the computing device 600 may retrieve, i.e., request and receive, the participant-specific ML model from a cloud storage which is associated with the participant 101 and accessible by the computing device 600 (not illustrated in FIGS. 5A-5C). The latter may, e.g., be the case if the participant-specific ML model is stored in a cloud storage (such as iCloud, One Drive, etc) and is associated with a user identifier of the participant 101 (such as Apple ID, email address of the participant 101, etc).

The processing circuitry 602 optionally further causes the computing device 600 to be operative to train 510 the ML model using at least the outer part 330 of the captured 3D representation 300 and the determined 504 pose of the head 102. That is, the outer part 330 of the captured 3D representation 300 is extracted, e.g., simultaneously with extracting 506 the inner part 320 of the captured 3D representation 300, and used as input for training 510 the ML model, together with the determined 504 pose of the head 102. Optionally, the computing device 600 may be operative to train 510 the ML model further based on the inner part 320 of the captured 3D representation 300, i.e., using the substantially complete captured 3D representation 300 of the head 102. This is advantageous in that the ML model which is used for generating 507 the avatar representation corresponding to the outer part 320 of the captured 3D representation 300 may be trained 510 for the specific head 102 of the participant 101 while the video communication session commences. The ML model may, e.g., be a generic ML model which is trained for human heads in general. Alternatively, the ML model may be a specific ML model which is trained for certain types of human heads, as is described hereinbefore. As yet another alternative, the ML model may be a participant-specific ML model which has been trained during previous video communication sessions, or during a dedicated training procedure, and stored for later use in a data storage associated with the participant 101, e.g., a data storage comprised in the sending computing device 110 or a cloud storage.

The captured 3D representation, the inner part of the captured 3D representation, the merged 3D representation, and the avatar representation, may be stored, and transmitted between the sending computing device 110, the edge computing device 120, and the receiving computing device 130, via the communications network 140, using any suitable data format, in particular 3D immersive-media formats, and/or protocols. More specifically, the captured 3D representation, the inner and outer parts of the captured 3D representation, the merged 3D representation, and the avatar representation, may be stored and transmitted as point clouds, meshes, or depth map images. A point cloud is a set of data points in space, the points representing a 3D object such as the head 102. A mesh, also referred to as polygon mesh, is a collection of vertices, edges and faces that defines the shape of a 3D object such as the head 102. A depth map image contains information relating to the distance of the surfaces of a 3D object, such as the head 102, from a viewpoint, in particular that of the 3D sensor 111. Protocols used for transmitting the captured 3D representation, the inner part of the captured 3D representation, the merged 3D representation, and the avatar representation, between, the sending computing device 110, the edge computing device 120, and the receiving computing device 130, via the communications network 140, include, but are not limited to, RTP, SRTP, Dynamic Adaptive Streaming over HTTP (DASH), etc.

In the following, and with reference to FIGS. 5A-5C, different embodiments of the invention are illustrated, with particular focus on at which of the sending computing device 110, the edge computing device 120, and the receiving computing device 130, the operations involved in generating a 3D representation of a head of a human may be performed.

The embodiment illustrated in FIG. 5A is characterized by an edge-centric processing. This is advantageous in that the edge computing device 120 typically has an abundance of computing resources, in terms of computing power, memory, and electrical power supply, as compared to the sending computing device 110 and the receiving computing device 130, which may be embodied as smartphones, tablets, HMDs, or other types of mobile computing devices which oftentimes are battery powered and less powerful in terms of processing power.

More specifically, if the computing device 600 for generating a 3D representation of a head 102 of a participant 101 in a video communication session is embodied as the edge computing device 120, the edge computing device 120 is operative to acquire a captured 3D representation of the head by receiving 512 the captured 3D representation of the head 102 from the sending computing device 110. The edge computing device 120 is further operative to identify 503 positions of a set of facial landmarks in the captured 3D representation, which set of facial landmarks comprises facial landmarks indicative of a boundary of the human face. The edge computing device 120 is further operative to determine 504 a pose of the head 102. The edge computing device 120 is further operative to determine 505 a boundary 310 between an inner part 320 and an outer part 330 of the captured 3D representation 300, based on the identified 503 positions of the set of facial landmarks. The inner part 320 of the captured 3D representation 300 represents the face of the participant 101. The edge computing device 120 is further operative to generate 507 an avatar representation corresponding to the outer part 330 of the captured 3D representation 300, using an ML model trained for human heads, with the determined 504 pose of the head 102 as input.

Optionally, the edge computing device 120 may further be operative to extract 506 the inner part 320 of the captured 3D representation 300, and to merge 508 the extracted inner part 320 of the captured 3D representation 300 and the generated avatar representation into a merged 3D representation of the head 102.

The edge computing device 120 may further be operative to transmit 521 the merged 3D representation of the head 102 to the receiving computing device 130, where it is displayed 509 using the display device 131.

Optionally, the edge computing device 120 may be operative to train 510 the ML model using at least the outer part 330 of the captured 3D representation 300 and the determined 504 pose of the head. Further optionally, the edge computing device 120 may be operative to train 510 the ML model further based on the inner part 320 of the captured 3D representation 300.

Compared to the edge-centric embodiment illustrated in FIG. 5A, in the embodiment illustrated in FIG. 5B and described in the following, part of the processing has been moved from the edge computing device 120 to the receiving computing device 130. In this case, the edge computing device 120 and the receiving computing device 130 in combination implement embodiments of the invention. In other words, the invention is embodied as a system of computing devices for generating a 3D representation of a head of a participant in a video communication session.

More specifically, the edge computing device 120 is operative to acquire a captured 3D representation of the head by receiving 512 the captured 3D representation of the head 102 from the sending computing device 110. The edge computing device 120 is further operative to identify 503 positions of a set of facial landmarks in the captured 3D representation, which set of facial landmarks comprises facial landmarks indicative of a boundary of the human face. The edge computing device 120 is further operative to determine 504 a pose of the head 102, and to transmit 523 the determined pose of the head 102 to the receiving computing device 130. The edge computing device 120 is further operative to determine 505 a boundary 310 between an inner part 320 and an outer part 330 of the captured 3D representation 300, based on the identified 503 positions of the set of facial landmarks. The inner part 320 of the captured 3D representation 300 represents the face of the participant 101. The edge computing device 120 is optionally further operative to extract 506 the inner part 320 of the captured 3D representation 300, and to transmit 524 the extracted inner part 320 of the captured 3D representation 300 to the receiving computing device 130.

The receiving computing device 130 is operative to generate 507 an avatar representation corresponding to the outer part 330 of the captured 3D representation 300, using an ML model trained for human heads, with the determined 504 pose of the head 102 which the receiving computing device 130 has received 523 as input. Optionally, the receiving computing device 130 is operative to merge 508 the received 524 inner part 320 of the captured 3D representation 300 and the generated 507 avatar representation into a merged 3D representation of the head 102. The receiving computing device 130 may further be operative to display 509 the merged 3D representation of the head 102 using the display device 131.

Optionally, the edge computing device 120 may further be operative to train 510 the ML model using at least the outer part 330 of the captured 3D representation 300 and the determined 504 pose of the head. Further optionally, the edge computing device 120 may be operative to train 510 the ML model further based on the inner 320 part of the captured 3D representation 300, i.e., using the substantially complete captured 3D representation of the head 102. In this case, the edge computing device 120 is operative to transmit 525 the updated ML model to the receiving computing device 130.

A further embodiment of a system of computing devices for generating a 3D representation of a head of a participant in a video communication session is illustrated in FIG. 5C. Compared to the embodiment illustrated in FIG. 5B, additional operations involved in generating a 3D representation of the head 102 have been moved from the edge computing device 120 to the receiving computing device 130.

More specifically, the edge computing device 120 is operative to acquire a captured 3D representation of the head by receiving 512 the captured 3D representation of the head 102 from the sending computing device 110. The edge computing device 120 is further operative to identify 503 positions of a set of facial landmarks in the captured 3D representation, which set of facial landmarks comprises facial landmarks indicative of a boundary of the human face. The edge computing device 120 is further operative to determine 504 a pose of the head 102, and to transmit 523 the determined pose of the head 102 to the receiving computing device 130. The edge computing device 120 is further operative to determine 505 a boundary 310 between an inner part 320 and an outer part 330 of the captured 3D representation 300, based on the identified 503 positions of the set of facial landmarks, and to transmit 527 the determined boundary between the inner part and the outer part to the receiving computing device 130. The inner part of the captured 3D representation represents the face of the participant 101.

The receiving computing device 120 is optionally operative to extract 506 the inner part 320 of the captured 3D representation 300, using the received 527 boundary 310 between the inner part 320 and the outer part 330 of the captured 3D representation 300.

The receiving computing device 130 is operative to generate 507 an avatar representation corresponding to the outer part 330 of the captured 3D representation 300, using an ML model trained for human heads, with the determined 504 pose of the head 102 which the receiving computing device 130 has received 523 as input. Optionally, the receiving computing device 130 is operative to merge 508 the received 524 inner part 320 of the captured 3D representation 300 and the generated 507 avatar representation into a merged 3D representation of the head 102. The receiving computing device 130 may further be operative to display 509 the merged 3D representation of the head 102 using the display device 131.

Optionally, the receiving computing device 130 may further be operative to train 510 the ML model using at least the outer part 330 of the captured 3D representation 300 and the determined 504 pose of the head. Further optionally, the edge computing device 120 may be operative to train 510 the ML model further based on the inner part 320 of the captured 3D representation 300, i.e., using the substantially complete captured 3D representation 300 of the head 102.

Although embodiments of the invention have been described with specific distributions of the operations involved in generating a 3D representation of a head of a participant in a video communication session among the sending computing device 110, the edge computing device 120, and the receiving computing device 130, respectively, as illustrated in FIGS. 5A-5C, the person skilled in the art may easily envisage alternatives for distributing the operations involved in generating a 3D representation of a head of a participant in a video communication session among the sending computing device 110, the edge computing device 120, and the receiving computing device 130.

In the following, embodiments of the processing circuitry 602 which is comprised in the computing device 600 for generating 3D representation of a head of a participant in a video communication session are described with reference to FIG. 6. Embodiments of the processing circuitry 600 may be comprised in one or more of the sending computing device 110, the edge computing device 120, and the receiving computing device 130.

The processing circuitry 602 may comprise one or more processors 603, such as Central Processing Units (CPUs), microprocessors, application processors, application-specific processors, Graphics Processing Units (GPUs), and Digital Signal Processors (DSPs) including image processors, or a combination thereof, and a memory 604 comprising a computer program 605 comprising instructions. When executed by the processor(s) 603, the instructions cause the computing device 600 to become operative in accordance with embodiments of the invention described herein. If the operations involved in generating a 3D representation of a head of a participant in a video communication session are distributed among two or more of the sending computing device 110, the edge computing device 120, and the receiving computing device 130, their respective instructions cause the two or more of the sending computing device 110, the edge computing device 120, and the receiving computing device 130, when executed by their respective processors 603, to become operative in accordance with embodiments of the invention described herein in a collaborative fashion. The memory 604 may, e.g., be a Random-Access Memory (RAM), a Read-Only Memory (ROM), a Flash memory, or the like. The computer program 605 may be downloaded to the memory 604 by means of the network interface circuitry 601, as a data carrier signal carrying the computer program 605. The processing circuitry 602 may alternatively or additionally comprise one or more Application-Specific Integrated Circuits (ASICs), Field-Programmable Gate Arrays (FPGAs), or the like, which are operative to cause the computing device 600 to become operative in accordance with embodiments of the invention described herein.

The network interface circuitry 601 may comprise one or more of a cellular modem (e.g., GSM, UMTS, LTE, 5G, or higher generation), a WLAN/Wi-Fi modem, a Bluetooth modem, an Ethernet interface, an optical interface, or the like, for exchanging data between the computing device 600 and other computing devices, in particular between the sending computing device 110, the edge computing device 120, and the receiving computing device 130, and the communications network 140, which may comprise the Internet and one or more RANs.

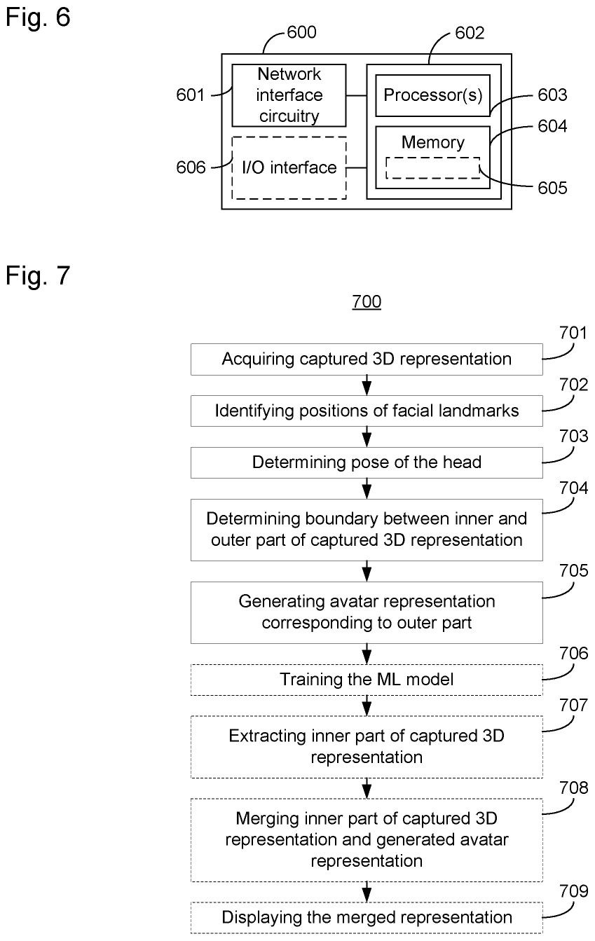

In the following, embodiments of the method 700 of generating a 3D representation of a head 102 of a participant 101 in a video communication session are described with reference to FIG. 7.

The method 700 is performed by a computing device 600 and comprises acquiring 701 a captured 3D representation of the head 102, and identifying 702 positions of a set of facial landmarks in the captured 3D representation. The set of facial landmarks comprises facial landmarks which are indicative of a boundary of the human face. The method 700 further comprises determining 703 a pose of the head 102, and determining 704 a boundary between an inner part and an outer part of the captured 3D representation. The boundary is determined 704 based on the identified 702 positions of the set of facial landmarks. The inner part of the captured 3D representation represents the face of the participant. The method 700 further comprises generating 705 an avatar representation corresponding to the outer part of the captured 3D representation. The avatar representation is generated 705 using an ML model trained for human heads, with the determined 703 pose of the head 102 as input. The ML model may optionally be trained for the head 102 of the participant 101.

The method 700 optionally further comprises extracting 707 the inner part of the captured 3D representation, and merging 708 the extracted 707 inner part of the captured 3D representation and the generated 705 avatar representation into a merged 3D representation of the head 102.

The method 700 optionally further comprises displaying 709 the merged 3D representation of the head 102 using a display device 131. The display device 131 may be any one of a computer display, a television, an AR device, a VR device, an MR device, an XR device, and an HMD device.

The acquiring 701 a captured 3D representation of the head 102 may comprise capturing the 3D representation of the head 102 using a 3D sensor 111. The 3D sensor 111 may comprise one or more of a 3D camera, a LIDAR, and an optical 3D sensor.

The method 700 optionally further comprises acquiring the ML model from a data storage associated with the participant 101.

The method 700 optionally further comprises training 706 the ML model using at least the outer part of the captured 3D representation and the determined 703 pose of the head. The ML model is optionally trained further based on the inner part of the captured 3D representation.

It will be appreciated that the method 700 may comprise additional, alternative, or modified, steps in accordance with what is described throughout this disclosure. The method may also be performed by more than one computing device, e.g., two or more of the sending computing device 110, the edge computing device 120, and the receiving computing device 130, in a collaborative fashion. An embodiment of the method 700 may be implemented as the computer program 605 comprising instructions which, when the computer program 605 is executed by the computing device 600 cause the computing device 600 to carry out the method 700 and become operative in accordance with embodiments of the invention described herein. The computer program 605 may be stored in a computer-readable data carrier, such as the memory 604. Alternatively, the computer program 605 may be carried by a data carrier signal, e.g., downloaded to the memory 604 via the network interface circuitry 601.

The person skilled in the art realizes that the invention by no means is limited to the embodiments described above. On the contrary, many modifications and variations are possible within the scope of the appended claims.

1.-25. (canceled)

26. A computing device for generating a three-dimensional (3D) representation of a head of a participant in a video communication session, the computing device comprising processing circuitry configured to cause the computing device to be operative to:
acquire a captured 3D representation of the head,
identify positions of a set of facial landmarks in the captured 3D representation, the set of facial landmarks comprising facial landmarks indicative of a boundary of the human face,
determine a pose of the head,
determine a boundary between an inner part and an outer part of the captured 3D representation, based on the identified positions of the set of facial landmarks, the inner part of the captured 3D representation representing the face of the participant, and
generate an avatar representation corresponding to the outer part of the captured 3D representation, using a Machine-Learning (ML) model trained for human heads, with the determined pose of the head as input.

27. The computing device according to claim 26, the processing circuitry configured to cause the computing device to be further operative to:
extract the inner part of the captured 3D representation, and
merge the extracted inner part of the captured 3D representation and the generated avatar representation into a merged 3D representation of the head.

28. The computing device according to claim 27, the processing circuitry configured to cause the computing device to be further operative to display the merged 3D representation of the head using a display device.

29. The computing device according to claim 28, wherein the display device is any one of: a computer display, a television, an Augmented-Reality (AR) device, a Virtual-Reality (VR) device, a Mixed-Reality (MR) device, an extended-Reality (XR) device, and a Head-Mounted Display (HMD) device.

30. The computing device according to claim 26, the processing circuitry configured to cause the computing device to be operative to acquire the captured 3D representation of the head by capturing the 3D representation of the head using a 3D sensor.

31. The computing device according to claim 30, wherein the 3D sensor comprises one or more of: a 3D camera, a LIDAR, and an optical 3D sensor.

32. The computing device according to claim 26, wherein the ML model is trained for the head of the participant.

33. The computing device according to claim 32, the processing circuitry configured to cause the computing device to be further operative to acquire the ML model from a data storage associated with the participant.

34. The computing device according to claim 26, the processing circuitry configured to cause the computing device to be further operative to train the ML model using at least the outer part of the captured 3D representation and the determined pose of the head.

35. The computing device according to claim 34, the processing circuitry configured to cause the computing device to be operative to train the ML model further based on the inner part of the captured 3D representation.

36. The computing device according to claim 26, wherein the captured 3D representation, the inner part of the captured 3D representation, the merged 3D representation, and the avatar representation are point clouds, meshes, or depth map images.

37. A method of generating a three-dimensional (3D) representation of a head of a participant in a video communication session, the method being performed by a computing device and comprising:
acquiring a captured 3D representation of the head,
identifying positions of a set of facial landmarks in the captured 3D representation, the set of facial landmarks comprising facial landmarks indicative of a boundary of the human face,
determining a pose of the head,
determining a boundary between an inner part and an outer part of the captured 3D representation, based on the identified positions of the set of facial landmarks, the inner part of the captured 3D representation representing the face of the participant, and
generating an avatar representation corresponding to the outer part of the captured 3D representation, using a Machine-Learning (ML) model trained for human heads, with the determined pose of the head as input.

38. The method according to claim 37, further comprising:
extracting the inner part of the captured 3D representation, and
merging the extracted inner part of the captured 3D representation and the generated avatar representation into a merged 3D representation of the head.

39. The method according to claim 38, further comprising displaying the merged 3D representation of the head using a display device.

40. The method according to claim 39, wherein the display device is any one of: a computer display, a television, an Augmented-Reality (AR) device, a Virtual-Reality (VR) device, a Mixed-Reality (MR) device, an extended-Reality (XR) device, and a Head-Mounted Display (HMD) device.

41. The method according to claim 37, wherein the acquiring a captured 3D representation of the head comprises capturing the 3D representation of the head using a 3D sensor.

42. The method according to claim 41, wherein the 3D sensor comprises one or more of: a 3D camera, a LIDAR, and an optical 3D sensor.

43. The method according to claim 37, wherein the ML model is trained for the head of the participant.

44. The method according to claim 43, further comprising acquiring the ML model from a data storage associated with the participant.

45. The method according to claim 37, further comprising training the ML model using at least the outer part of the captured 3D representation and the determined pose of the head.

46. The method according to claim 45, wherein the ML model is trained further based on the inner part of the captured 3D representation.

47. The method according to claim 37, wherein the captured 3D representation, the inner part of the captured 3D representation, the merged 3D representation, and the avatar representation, are point clouds, meshes, or depth map images.

48. A computer-readable storage medium on which is stored a computer program comprising instructions which, when executed by a computing device, causes the computing device generate a three-dimensional (3D) representation of a head of a participant in a video communication session by:
acquiring a captured 3D representation of the head,
identifying positions of a set of facial landmarks in the captured 3D representation, the set of facial landmarks comprising facial landmarks indicative of a boundary of the human face,
determining a pose of the head,
determining a boundary between an inner part and an outer part of the captured 3D representation, based on the identified positions of the set of facial landmarks, the inner part of the captured 3D representation representing the face of the participant, and
generating an avatar representation corresponding to the outer part of the captured 3D representation, using a Machine-Learning (ML) model trained for human heads, with the determined pose of the head as input.
